(19) United States
(12) Patent Application Publication
(10) Pub. No.: US 2021/0014398 A1
(43) Pub. Date: Jan. 14, 2021

(54) PHOTOGRAPHING METHOD, DEVICE, AND SYSTEM

(71) Applicant: BEIJING XIAOMI MOBILE SOFTWARE CO., LTD., Beijing (CN)

(72) Inventor: Tao JIN, Beijing (CN)

(73) Assignee: BEIJING XIAOMI MOBILE SOFTWARE CO., LTD., Beijing (CN)

(21) Appl. No.: 16/680,489

(22) Filed: Nov. 11, 2019

(30) Foreign Application Priority Data
Jul. 12, 2019 (CN) 201910628473.9

(51) Int. Cl. H04N 5/232; H04N 5/262; G06F 3/0488

(52) U.S. Cl. CPC H04N 5/232; G06F 3/0482; G06F 3/0488; H04N 5/2628

(57) ABSTRACT

A photographing method includes: receiving an instruction to perform photography alignment; providing a user interface to select a reference picture, the reference picture including a photo or an image of a video; determining a marker of a target for alignment in the reference picture, the target including at least one object; and displaying a processed reference picture in a screen; wherein the processed reference picture includes the marker, such as a contour of the target. As such, a photographer can locate a photographed subject in an image accurately according to a processed reference picture including the marker in the screen, and restoring a scene in the reference picture more accurately.

### CROSS-REFERENCE TO RELATED APPLICATION

This application claims priority to Chinese patent application No. 201910628473.9 filed on Jul. 12, 2019, the disclosure of which is hereby incorporated by reference in its entirety.

### BACKGROUND

An image or a picture of a same scene may have to be photographed again such as when video recording is accidentally interrupted, and resumed, with an expectation that content of the image or picture photographed at the time is to be as similar as possible to that of an image or a picture photographed at a previous time. In this case, an accurate location of a photographed subject in a previous shot may have to be determined. As another example, in remembrance of an important experience, one may go to one place the same time every year expecting to take a picture of a same background at a same angle as of a picture taken in a previous year. The photographer may rely on his or her memory, or a picture or photo taken previously, as a simple reference. A resulting photo may often differ a lot from what is expected, failing to satisfy the user.

### SUMMARY

The subject disclosure relates to photography and video recording, and in particular to a photographing method and device, and a storage medium.

According to an aspect of embodiments herein, a photographing method includes:

receiving an instruction to perform photography alignment;

providing a user interface to select a reference picture, the reference picture including a photo or an image of a video;

determining a marker of a target for alignment in the reference picture, the target including at least one object; and

displaying a processed reference picture in a screen;

wherein the processed reference picture includes the marker.

According to an aspect of embodiments herein, a photographing device includes a processor and memory.
wherein the memory stores an instruction executable by the processor, the processor is adapted to implement a photographing method, and the photographing method includes:

receiving an instruction to perform photography alignment;

providing a user interface to select a reference picture, the reference picture including a photo or an image of a video;

determining a marker of a target for alignment in the reference picture, the target including at least one object; and

displaying a processed reference picture in a screen;

wherein the processed reference picture includes the marker.

According to an aspect of embodiments herein, a non-transitory computer-readable storage medium has stored thereon instructions that, when executed by a processor of mobile User Equipment (UE), cause the mobile UE to implement a photographing method. The method includes:

receiving an instruction to perform photography alignment;

providing a user interface to select a reference picture, the reference picture including a photo or an image of a video;

determining a marker of a target for alignment in the reference picture, the target including at least one object; and

displaying a processed reference picture in a screen;

wherein the processed reference picture includes the marker.

In another aspect, a photographing method, implemented by a mobile phone, is provided, wherein the mobile phone includes at least one touch panel and a display screen, the method includes:

displaying a standby user interface;

determining a reference photo of the mobile phone according to information obtained by a user;

receiving a click on the reference photo to select at least one target;

in response to the click having been received, automatically starting a marker extraction of the at least one target for aligning in the reference picture; and

displaying the marker of the at least one target for aligning in the display screen.

The above general description and the following detailed description are only exemplary and explanatory, and are not intended to limit the subject disclosure.

### BRIEF DESCRIPTION OF THE DRAWINGS

The accompanying drawings referred to in the specification are a part of this disclosure, and provide illustrative embodiments consistent with the disclosure and, together with the detailed description, serve to illustrate some embodiments of the disclosure.

FIG. 1 is a flowchart of a photographing method according to some embodiments of the present disclosure.

FIG. 2 is a diagram of a reference picture according to some embodiments of the present disclosure.

FIG. 3 is a diagram of a marked reference picture according to some embodiments of the present disclosure.

FIG. 4 is a block diagram of a photographing device according to some embodiments of the present disclosure.

FIG. 5 is a block diagram of a photographing device according to some embodiments of the present disclosure.

### DETAILED DESCRIPTION

Exemplary embodiments (examples of which are illustrated in the accompanying drawings) are elaborated below. The following description refers to the accompanying drawings, in which identical or similar elements in two drawings are denoted by identical reference numerals unless indicated otherwise. The exemplary implementation modes may take on multiple forms, and should not be taken as being limited to examples illustrated herein. Instead, by providing such implementation modes, embodiments herein may become more comprehensive and complete, and comprehensive concept of the exemplary implementation modes may be delivered to those skilled in the art. Implementations set forth in the following exemplary embodiments do not represent all implementations in accordance with the subject disclosure. Rather, they are merely examples of the apparatus and method in accordance with certain aspects herein as recited in the accompanying claims.

A term used in an embodiment herein is merely for describing the embodiment instead of limiting the subject disclosure. A singular form “a” and “the” used in an embodiment herein and the appended claims may also be intended to include a plural form, unless clearly indicated otherwise by context. Further, it should be noted that a term “and/or” used herein may refer to and contain any combination or all possible combinations of one or more associated listed items.

Note that although a term such as first, second, third may be adopted in an embodiment herein to describe various kinds of information, such information should not be limited to such a term. Such a term is merely for distinguishing information of the same type. For example, without departing from the scope of the embodiments herein, the first information may also be referred to as the second information. Similarly, the second information may also be referred to as the first information. Depending on the context, a “if” as used herein may be interpreted as “when” or “while” or “in response to determining that”.

In addition, described characteristics, structures or features may be combined in one or more implementation modes in any proper manner. In the following descriptions, many details are provided to allow a full understanding of embodiments herein. However, those skilled in the art will know that the technical solutions of embodiments herein may be carried out without one or more of the details; In some embodiments, another method, component, device, operation, etc. may be adopted. Under other conditions, no detail of a known structure, method, device, implementation, material or operation may be shown or described to avoid obscuring aspects of embodiments herein.

A block diagram shown in the accompanying drawings may be a functional entity which may not necessarily correspond to a physically or logically independent entity. Such a functional entity may be implemented in form of software, in one or more hardware portions or integrated circuits, or in different networks and/or processor devices and/or microcontroller devices.

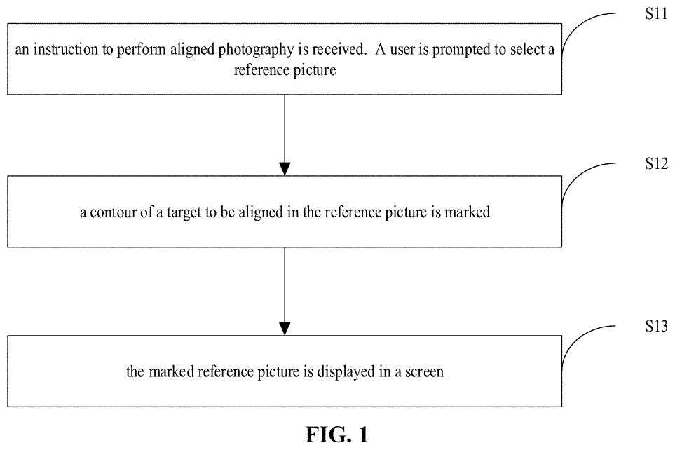

FIG. 1 is a flowchart of a photographing method according to some embodiments of the present disclosure. As shown in FIG. 1, the photographing method includes at least one operation as follows.

In S11, an instruction to perform aligned photography is received. A user is prompted to select a reference picture. The reference picture can include, for example, a picture, a photo, or an image that is a frame of a video. This photographing function can be preset in photographing equipment, such as a smart camera, a smart phone, a tablet computer, etc.

To perform the aligned photography, the user can first select the aligned photography function. Having received the instruction, the equipment can activate an aligned photography mode and prompt the user to select the reference picture.

In S12, a marker of a target to be aligned in the reference picture can be designated or extracted. The marker can be, for example, a contour of the target. In another example, the marker can be some marker points at certain positions of the target, such as key positional points or points along the contour. A processed reference picture can be determined. The processed reference picture can be, for example, the reference picture overlaid or marked with the marker such as the contour. In another example, the processed reference picture can be the marker, such as the contour, itself. In yet another example, the processed reference picture can include just an abstract of the reference picture, such as line(s) and/or dots representing geometrical features of the reference picture.

The target can include, for example, at least one of a person or an object. In aligned photography, at least one of a person or an object can be selected as the target to be aligned as needed. The contour of the target selected by the user can be marked. The contour of a target image can be marked according to a certain rule and algorithm. For example, the contour of a target image can be acquired by edge searching and stylization in image processing or by adjusting a threshold. In general, the contour of a target image can be acquired using any feasible method, which is not limited herein.

In S13, the marked reference picture is displayed in a screen. In this way, in photographing, a photographer can refer to the processed reference picture, such as the marked reference picture, to align a photographed subject accurately in terms of its location and stance, and perform adjustment timely, thereby acquiring an image as expected. Of course, before referring to a marked reference picture, necessary processing can have to be performed on the marked reference picture, to allow a photographer to observe the location and stance of a photographed subject through the reference picture, so as to perform adjustment anytime.

In S11, the reference picture can include a picture taken in advance.

The reference picture can include a picture received from other equipment.

The reference picture can include a picture downloaded by a browser or an application (APP).

A photographer can select any picture as a reference picture according to personal preference.

In S12, the contour of the target to be aligned in the reference picture can be marked as follows.

The contour of the target to be aligned can be displayed using a line. Transparency of a part of the reference picture other than the line of the contour can be set. The transparency can range from 0% to 100%. For clearer and more distinct contour marking, the contour of a target can be outlined using a line. Meanwhile, to avoid blocking view of content to be photographed, the part of the marked reference picture other than the line of the contour can be adjusted to be completely transparent or semitransparent.

Adjusting the part of the reference picture other than the line of the contour to be completely transparent can render a hollow effect where only the line of the contour in the reference picture is displayed in a viewfinder screen, which suits photographing of a simple scene.

Adjusting the part of the reference picture other than the line of the contour to be semitransparent, such as with transparency of 50%, may leave, in the viewfinder screen, a faint shadow of scenery of the reference picture, and a photographed subject can be observed through the reference picture, which suits photographing of a complicated scene. In this way, the photographer can observe the photographed subject through the transparent or semitransparent part of the reference picture and guide adjustment of the location and the stance of the photographed subject.

The contour of the target to be aligned can include at least one of an external contour or an internal contour. At least one of an external contour or an internal contour can be selected and used according to a degree of complicacy of a target to be photographed. For example, in taking a group photo, as persons or individuals in the group photo stays closely to each other, an external contour can outline only an overall external contour of multiple individuals, in which case it is inconvenient to locate each individual. If an internal contour, such as that of a face, is used in addition to the external contour, each individual can be located according to a face contour based on the external contour.

The target can include a primary target and a secondary target. The contour of the target to be aligned can be displayed using a line as follows. A contour of the primary target to be aligned can be displayed using at least one of a first color or a line of a first type. A contour of the secondary target to be aligned can be displayed using at least one of a second color or a line of a second type.

For example, in a complicated scene, a number of arms can appear beside an individual. In this case, if only the contours of the individual and the arms are marked, in aligned photography the photographer cannot be able to tell which contours belong to the arms of the individual to be photographed, rendering the photographer confused. Therefore, in marking a contour of a person in the reference picture, the contour of a primary person can be marked using a solid red line, and the contour of a secondary person may be marked using a dotted yellow line. Then, the persons may be distinguished and recognized easily by the photographer.

Various embodiments are described below in more detail by way of examples of specific application scenarios.

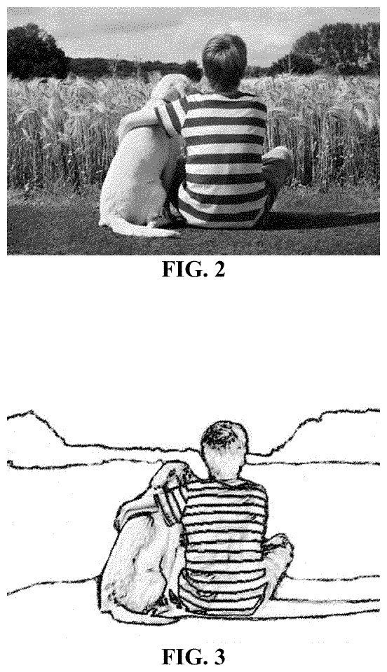

In a scenario, Mr. Li is a photography enthusiast. His son likes their pet dog. Once on a family tour, Mr. Li saw his son sitting together with the pet dog by a golden wheat field, overlooking the distant woods. The entire picture was full of harmony, happiness, and vision for the future. Mr. Li was touched and felt lucky to have captured this happy moment, as shown in FIG. 2. Mr. Li felt a need to frequent and refresh the touching feeling with the family to remind himself and his family to cherish the present blessing. He suggested that the family should go to the place to have an identical photo taken same time every year.

Accordingly, Mr. Li and his family visited the place in each of the following years and had a photo taken which has a scene identical to that taken years ago. However, every time he looked at the photos taken over the years, Mr. Li realized that either there was something missing in scenery of the photos, or the respective angles at which they had been taken were different, which was rather a fly in the ointment.

After purchasing a new cell phone, he finds that the camera of the cell phone is provided with an aligned photography function. Therefore, he uploads the most satisfactory photo to the cell phone and visits the place in the photo again with his family. Mr. Li starts the camera APP and clicks on a button for the aligned photography function. The APP prompts to select a reference photo. Mr. Li selects the most satisfactory photo, and clicks on the image of his son, the image of the pet dog, and the image of the distant woods one by one as targets to be aligned. Soon, contour lines of the target images appear in the viewfinder, as shown in FIG. 3. Mr. Li aligns the distant woods with the line of the contour of the woods in the viewfinder, has his son and the pet dog sit in front of the camera, and adjusts the locations. He soon takes a photo identical to that taken years ago, which makes him excited.

In another example, Zhang, a director, is filming an action movie. As a group of shots are about to be completed, there is an accident on the film site, where an actor is injured while completing an action. This brings the filming to a stop. An examination shows that the actor has to rest for a week.

One week later, the filming is to be resumed. An assistant asks Zhang the director whether the group of shots have to be re-filmed. Zhang says that re-filming is not needed because latest equipment is used for the filming, which may recover the interrupted scene. Therefore, the photographer retrieves the video at the interruption. Zhang selects a proper image from the video, selects a primary actor in the image as a primary target, and selects an extra as a secondary target. The video recorder or camera soon outlines contours of the actors.

The contour of the primary actor is outlined using a solid red line. The contour of the extra is outlined using a dotted green line. A part other than the lines of the contours is made semitransparent. Zhang sits in front of the camera, guides persons on the site to their places according to the lines of the contours of the actors, sets up the scene according to the shadow in the semitransparent part of the reference picture, and complete the last shots in the group of shots in a fast and smooth way. The crew feels that use of the new camera in the filming avoids a lot of repetitive work, saves days of time, and minimizes the loss brought about by the accident.

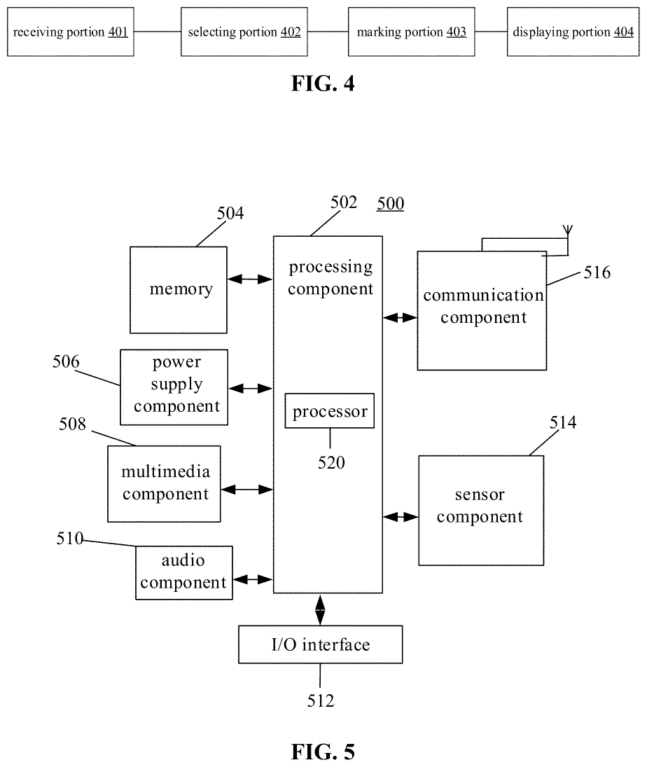

FIG. 4 is a block diagram of a photographing device according to some embodiments of the present disclosure. Referring to FIG. 4, the device includes a receiving portion 401, a selecting portion 402, a marking portion 403, and a displaying portion 404.

The receiving portion 401 is adapted to receiving an instruction to perform aligned photography.

The selecting portion 402 is adapted to prompting a user to select a reference picture.

The marking portion 403 is adapted to marking a contour of a target to be aligned in the reference picture.

The displaying portion 404 is adapted to displaying the marked reference picture in a screen.

The reference picture may include a picture taken in advance. The reference picture may include a picture received from other equipment. The reference picture may include a picture downloaded by a browser or an application (APP).

The marking portion 403 may mark the contour of the target to be aligned in the reference picture as follows. The marking portion may display, using a line, the contour of the target to be aligned. The marking portion may set transparency of a part of the reference picture other than the line of the contour. The transparency may range from 0% to 100%.

The contour of the target to be aligned may include at least one of an external contour or an internal contour.

The target may include a primary target and a secondary target. The contour of the target to be aligned may be displayed using the line as follows.

A contour of the primary target to be aligned may be displayed using at least one of a first color or a line of a first type.

A contour of the secondary target to be aligned may be displayed using at least one of a second color or a line of a second type.

A photographing device includes a processor and memory.

The memory stores an instruction executable by the processor.

The processor is adapted to performing at least one operation as follows.

An instruction to perform aligned photography is received.

A user is prompted to select a reference picture. The reference picture includes a photo or an image that is a frame of a video.

A contour of a target to be aligned in the reference picture is marked. The target includes at least one of a person or an object.

The marked reference picture is displayed in a screen.

A portion of an aforementioned device may perform an operation in a way as elaborated in an embodiment regarding the method. The elaboration is not repeated here.

FIG. 5 is a block diagram of a photographing device 500 according to some embodiments of the present disclosure. For example, the device 500 can be a mobile phone, a smart camera having processing circuits built therein for image processing, a computer, digital broadcasting UE, a message transceiver, a game console, tablet equipment, medical equipment, fitness equipment, a personal digital assistant, etc.

Referring to FIG. 5, the device 500 may include at least one of a processing component 502, memory 504, a power supply component 506, a multimedia component 508, an audio component 510, an Input/Output (I/O) interface 512, a sensor component 514, or a communication component 516.

The processing component 502 may generally control an overall operation of the device 500, such as operations associated with display, a telephone call, data communication, a camera operation, a recording operation, etc. The processing component 502 may include one or more processors 520 to execute instructions so as to complete all or part of the operations of an aforementioned method. In addition, the processing component 502 may include one or more portions to facilitate interaction between the processing component 502 and other components. For example, the processing component 502 may include a multimedia portion to facilitate interaction between the multimedia component 508 and the processing component 502.

The memory 504 may be adapted to storing various types of data to support the operation at the equipment 500. Examples of such data may include instructions of any application or method adapted to operating on the device 500, contact data, phonebook data, messages, pictures, videos, etc. The memory 504 may be realized by any type of transitory or non-transitory storage equipment or a combination thereof, such as Static Random Access Memory (SRAM), Electrically Erasable Programmable Read-Only Memory (EEPROM), Erasable Programmable Read-Only Memory (EPROM), Programmable Read-Only Memory (PROM), Read-Only Memory (ROM), magnetic memory, flash memory, a magnetic disk, a compact disk, etc.

The power supply component 506 may supply electric power to various components of the device 500. The power supply component 506 may include a power management system, one or more power sources, and other components related to generating, managing, and distributing electricity for the device 500.

The multimedia component 508 may include a screen that provides an output interface between the device 500 and a user. The screen may include a Liquid Crystal Display (LCD) and a Touch Panel (TP). In some embodiments, an organic light-emitting diode (OLED) display or other types of displays can be adopted.

If the screen includes a TP, the screen may be realized as a touch screen to receive a signal input by a user. The TP may include one or more touch sensors for sensing touch, slide, and gestures on the TP. The one or more touch sensors not only may sense the boundary of a touch or slide move, but also detect the duration and pressure related to the touch or slide move. The multimedia component 508 may include at least one of a front camera or a rear camera. When the device 500 is in an operation mode such as a photographing mode or a video mode, at least one of the front camera or the rear camera may receive external multimedia data. Each of the front camera or the rear camera may be a fixed optical lens system or may have a focal length and be capable of optical zooming.

The audio component 510 may be adapted to outputting and/or inputting an audio signal. For example, the audio component 510 may include a microphone (MIC). When the device 500 is in an operation mode such as a call mode, a recording mode, a voice recognition mode, etc., the MIC may be adapted to receiving an external audio signal. The received audio signal may be further stored in the memory 504 or may be sent via the communication component 516. The audio component 510 may further include a loudspeaker adapted to outputting the audio signal.

The I/O interface 512 may provide an interface between the processing component 502 and a peripheral interface portion. Such a peripheral interface portion may be a keypad, a click wheel, a button, etc. Such a button may include but is not limited to at least one of a homepage button, a volume button, a start button, or a lock button.

The sensor component 514 may include one or more sensors for assessing various states of the device 500. For example, the sensor component 514 may detect an on/off state of the device 500 and relative positioning of components such as the display and the keypad of the device 500. The sensor component 514 may further detect a change in the position of the device 500 or of a component of the device 500, whether there is contact between the device 500 and a user, the orientation or acceleration/deceleration of the device 500, a change in the temperature of the device 500, etc. The sensor component 514 may include a proximity sensor adapted to detecting existence of a nearby object without physical contact. The sensor component 514 may further include an optical sensor such as a Complementary Metal-Oxide-Semiconductor (CMOS) or a Charge-Coupled-Device (CCD) image sensor used in an imaging application. The sensor component 514 may further include an acceleration sensor, a gyroscope sensor, a magnetic sensor, a pressure sensor, a temperature sensor, etc.

The communication component 516 may be adapted to facilitating wired or wireless communication between the device 500 and other equipment. The device 500 may access a wireless network based on a communication standard such as Wi-Fi, 2G, 3G . . . , or a combination thereof. The communication component 516 may broadcast related information or receive a broadcast signal from an external broadcast management system via a broadcast channel. The communication component 516 may include a Near Field Communication (NFC) portion for short-range communication. For example, the NFC portion may be based on technology such as Radio Frequency Identification (RFID), Infrared Data Association (IrDA), Ultra-Wideband (UWB) technology, Bluetooth (BT), etc.

The device 500 may be realized by one or more electronic components such as an Application Specific Integrated Circuit (ASIC), a Digital Signal Processor (DSP), a Digital Signal Processing Device (DSPD), a Programmable Logic Device (PLD), a Field Programmable Gate Array (FPGA), a controller, a microcontroller, a microprocessor, etc., to implement an aforementioned method.

Anon-transitory computer-readable storage medium including instructions, such as memory 504 including instructions, may be provided. The instructions may be executed by the processor 520 of the device 500 to implement an aforementioned method. For example, the non-transitory computer-readable storage medium may be Read-Only Memory (ROM), Random-Access Memory (RAM), Compact Disc Read-Only Memory (CD-ROM), a magnetic tape, a floppy disk, optical data storage equipment, etc.

A non-transitory computer-readable storage medium may include instructions which when executed by a processor of mobile UE, may cause the mobile UE to implement a photographing method. The method can include at least one of the following operations.

An instruction to perform aligned photography is received.

A user is prompted to select a reference picture. The reference picture includes a photo or an image that is a frame of a video.

A contour of a target to be aligned in the reference picture is marked. The target includes at least one of a person or an object.

The marked reference picture is displayed in a screen.

The processor or processing circuit may be a Central Processing Unit (CPU), a general-purpose processor, a Digital Signal Processor (DSP), an Application Specific Integrated Circuit (ASIC), and/or the like. A general-purpose processor may be a microprocessor, any conventional processor, and/or the like. Aforementioned memory may be a Read-Only Memory (ROM), a Random-Access Memory (RAM), a flash memory, a hard disk, a solid-state disk, and/or the like. A Subscriber Identity Module (SIM) card, also referred to as a smart card, may have to be installed on a digital mobile phone before the phone can be used. Content, such as information on a user of the digital mobile phone, an encryption key, a phonebook of the user, may be stored on the computer chip. An operation of the method according to any combination of embodiments herein may be executed by a hardware processor, or by a combination of hardware and software portions in the processor.

The above device, non-transitory computer-readable medium can realize a photographing method, implemented by a mobile phone for an example. The mobile phone can have a display screen, and or/a touch panel. In an example, the display screen can be a touch screen.

The method can includes: displaying a standby user interface; determining a reference photo of the mobile phone according to information obtained by a user; receiving a click on the reference photo to select at least one target; and in response to the click having been received, automatically starting a contour formation processing of the at least one target for aligning in the reference picture; and displaying the contour of the at least one target for aligning in the display screen.

The display screen can be a touch screen, and can be an LCD display or an OLED display, for example.

In some embodiments, the mobile phone can have a front-facing camera, the photographing method can further include starting the front-facing camera to collect an image and performing a photography alignment function corresponding to the reference photo and the image from the front-facing camera.

In some embodiments, the target includes a primary target and a secondary target, and the method further includes displaying a contour of the primary target for aligning by using a first color or a line of a first type; and displaying a contour of the secondary target for aligning by using a second color or a line of a second type.

In the present disclosure, the terms “installed,” “connected,” “coupled,” “fixed” and the like shall be understood broadly, and can be either a fixed connection or a detachable connection, or integrated, unless otherwise explicitly defined. These terms can refer to mechanical or electrical connections, or both. Such connections can be direct connections or indirect connections through an intermediate medium. These terms can also refer to the internal connections or the interactions between elements. The specific meanings of the above terms in the present disclosure can be understood by those of ordinary skill in the art on a case-by-case basis.

In the description of the present disclosure, the terms “one embodiment,” “some embodiments,” “example,” “specific example,” or “some examples,” and the like can indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described can be combined in a suitable manner in any one or more embodiments or examples. In addition, various embodiments or examples described in the specification, as well as features of various embodiments or examples, can be combined and reorganized.

In some embodiments, the control and/or interface software or app can be provided in a form of a non-transitory computer-readable storage medium having instructions stored thereon is further provided. For example, the non-transitory computer-readable storage medium can be a ROM, a CD-ROM, a magnetic tape, a floppy disk, optical data storage equipment, a flash drive such as a USB drive or an SD card, and the like.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, which is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium can be tangible.

The operations described in this disclosure can be implemented as operations performed by a data processing apparatus on data stored on one or more computer-readable storage devices or received from other sources.

The devices in this disclosure can include special purpose logic circuitry, e.g., an FPGA (field-programmable gate array), or an ASIC (application-specific integrated circuit). The device can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The devices and execution environment can realize various different computing model infrastructures, such as web services, distributed computing, and grid computing infrastructures.

A computer program (also known as a program, software, software application, app, script, or code) can be written in any form of programming language, including compiled or interpreted languages, declarative or procedural languages, and it can be deployed in any form, including as a stand-alone program or as a portion, component, subroutine, object, or other portion suitable for use in a computing environment. A computer program can, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more portions, sub-programs, or portions of code). A computer program can be deployed to be executed on one computer or on multiple computers that are located at one site or distributed across multiple sites and interconnected by a communication network.

The processes and logic flows described in this disclosure can be performed by one or more programmable processors executing one or more computer programs to perform actions by operating on input data and generating output. The processes and logic flows can also be performed by, and apparatus can also be implemented as, special purpose logic circuitry, e.g., an FPGA, or an ASIC.

Processors or processing circuits suitable for the execution of a computer program include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented with a computer and/or a display device, e.g., a VR/AR device, a head-mount display (HMD) device, a head-up display (HUD) device, smart eyewear (e.g., glasses), a CRT (cathode-ray tube), LCD (liquid-crystal display), OLED (organic light emitting diode), or any other monitor for displaying information to the user and a keyboard, a pointing device, e.g., a mouse, trackball, etc., or a touch screen, touch pad, etc., by which the user can provide input to the computer.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components.

The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombination.

Moreover, although features can be described above as acting in certain combinations and even initially claimed as such, one or more features from a claimed combination can in some cases be excised from the combination, and the claimed combination can be directed to a subcombination or variation of a sub combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

It is intended that the specification and embodiments be considered as examples only. Other embodiments of the disclosure will be apparent to those skilled in the art in view of the specification and drawings of the present disclosure. That is, although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the example embodiments, in addition to those described above, can be made by a person of ordinary skill in the art, having the benefit of the present disclosure, without departing from the spirit and scope of the disclosure defined in the following claims, the scope of which is to be accorded the broadest interpretation so as to encompass such modifications and equivalent structures.

It should be understood that “a plurality” or “multiple” as referred to herein means two or more. “And/or,” describing the association relationship of the associated objects, indicates that there may be three relationships, for example, A and/or B may indicate that there are three cases where A exists separately, A and B exist at the same time, and B exists separately. The character “/” generally indicates that the contextual objects are in an “or” relationship.

In the present disclosure, it is to be understood that the terms “lower,” “upper,” “under” or “beneath” or “underneath,” “above,” “front,” “back,” “left,” “right,” “top,” “bottom,” “inner,” “outer,” “horizontal,” “vertical,” and other orientation or positional relationships are based on example orientations illustrated in the drawings, and are merely for the convenience of the description of some embodiments, rather than indicating or implying the device or component being constructed and operated in a particular orientation. Therefore, these terms are not to be construed as limiting the scope of the present disclosure.

In the present disclosure, a first element being “on” a second element may indicate direct contact between the first and second elements, without contact, or indirect geometrical relationship through one or more intermediate media or layers, unless otherwise explicitly stated and defined. Similarly, a first element being “under,” “underneath” or “beneath” a second element may indicate direct contact between the first and second elements, without contact, or indirect geometrical relationship through one or more intermediate media or layers, unless otherwise explicitly stated and defined.

In the description of the present disclosure, the terms “some embodiments,” “example,” or “some examples,” and the like may indicate a specific feature described in connection with the embodiment or example, a structure, a material or feature included in at least one embodiment or example. In the present disclosure, the schematic representation of the above terms is not necessarily directed to the same embodiment or example.

Moreover, the particular features, structures, materials, or characteristics described may be combined in a suitable manner in any one or more embodiments or examples. In addition, various embodiments or examples described in the specification, as well as features of various embodiments or examples, may be combined and reorganized.

While this specification contains many specific implementation details, these should not be construed as limitations on the scope of any claims, but rather as descriptions of features specific to particular implementations. Certain features that are described in this specification in the context of separate implementations can also be implemented in combination in a single implementation. Conversely, various features that are described in the context of a single implementation can also be implemented in multiple implementations separately or in any suitable subcombinations.

Moreover, although features can be described above as acting in certain combinations and even initially claimed as such, one or more features from a claimed combination can in some cases be excised from the combination, and the claimed combination can be directed to a subcombination or variations of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

As such, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing can be utilized.

Some other embodiments of the present disclosure can be available to those skilled in the art upon consideration of the specification and practice of the various embodiments disclosed herein. The present application is intended to cover any variations, uses, or adaptations of the present disclosure following general principles of the present disclosure and include the common general knowledge or conventional technical means in the art without departing from the present disclosure. The specification and examples can be shown as illustrative only, and the true scope and spirit of the disclosure are indicated by the following claims.

1. A photographing method, comprising:
receiving an instruction to perform photography alignment;
providing a user interface to select a reference picture, the reference picture including a photo or an image of a video;
determining a marker of a target for alignment in the reference picture, the target including at least one object; and
displaying a processed reference picture in a screen;
wherein the processed reference picture includes the marker.

2. The photographing method of claim 1, wherein the reference picture further comprises one of:
a picture taken in advance;
a picture received from another equipment; or
a picture downloaded by a browser or an application (APP).

3. The photographing method of claim 1, wherein:
the marker comprises a contour of the target; and
the determining a marker of a target to for alignment in the reference picture comprises:
displaying the contour of the target for alignment by a line; and
setting transparency of a part of the reference picture other than the line of the contour with a transparency ranging from 0% to 100%.

4. The photographing method of claim 3, wherein the contour of the target to for alignment comprises at least one of an external contour or an internal contour.

5. The photographing method of claim 3, wherein the target comprises a primary target and a secondary target, wherein the displaying, using a line, the contour of the target for alignment comprises:
displaying a contour of the primary target by using a first color or a first type of line; and
displaying a contour of the secondary target to be aligned for alignment by using a second color or a second line.

6. A photographing device, comprising a processor and memory,
wherein the memory stores an instruction executable by the processor, the processor is adapted to implement a photographing method, and the photographing method comprises:
receiving an instruction to perform photography alignment;
providing a user interface to select a reference picture, the reference picture comprising a photo or an image a video;
determining a marker of a target to for alignment in the reference picture, the target comprising at least one object; and
displaying a processed reference picture in a screen;
wherein the processed reference picture includes the marker.

7. The photographing device of claim 6, wherein the reference picture further comprises at least one of:
a picture taken in advance;
a picture received from another equipment; or
a picture downloaded by a browser or an application (APP).

8. The photographing device of claim 6, wherein:
the marker comprises a contour of the target; and
the determining a marker of a target to be aligned in the reference picture comprises:
displaying the contour of the target for alignment by using a line; and
setting transparency of a part of the reference picture other than the line of the contour, with a transparency ranging from 0% to 100%.

9. The photographing device of claim 8, wherein the contour of the target to for alignment comprises at least one of an external contour or an internal contour.

10. The photographing device of claim 8, wherein the target comprises a primary target and a secondary target, wherein the contour of the target to be aligned is displayed using the line by:
displaying a contour of the primary target for alignment by using a first color or a line of a first type; and
displaying a contour of the secondary target to be aligned for alignment by using a second color or a second line.

11. A non-transitory computer-readable storage medium having stored thereon instructions that, when executed by a processor of mobile User Equipment (UE), cause the mobile UE to implement a photographing method, the method comprising:
receiving an instruction to perform photography alignment;
providing a user interface to select a reference picture, the reference picture comprising a photo or an image of a video;
determining a marker of a target for alignment in the reference picture, the target comprising at least one object; and
displaying a processed reference picture in a screen;
wherein the processed reference picture includes the marker.

12. The storage medium of claim 11, wherein the reference picture further comprises at least one of:
a picture taken in advance;
a picture received from another equipment; or
a picture downloaded by a browser or an application (APP).

13. The storage medium of claim 11, wherein:
the marker comprises a contour of the target; and
the determining a marker of a target to be aligned in the reference picture comprises:
displaying the contour of the target for alignment by using a line; and
setting transparency of a part of the reference picture other than the line of the contour, with a transparency ranging from 0% to 100%.

14. The storage medium of claim 13, wherein the contour of the target for alignment comprises at least one of an external contour or an internal contour.

15. The storage medium of claim 13, wherein the target comprises a primary target and a secondary target, wherein the contour of the target to be aligned is displayed using the line by:
displaying a contour of the primary target for alignment by using a first color or a line of a first type; and
displaying a contour of the secondary target to be aligned for alignment by using a second color or a second line.

16. A mobile device implementing the method according to claim 1, wherein the mobile device comprises a processing circuit configured to extract the marker.

17. The mobile device of claim 16, wherein the reference picture further comprises at least one of:
a picture taken in advance;
a picture received from other equipment; or
a picture downloaded by a browser or an application (APP).

18. The mobile device of claim 17, wherein:
the marker comprises a contour; and
the determining a marker of a target to be aligned in the reference picture comprises:
displaying, using a line, the contour of the target to be aligned; and
setting transparency of a part of the reference picture other than the line of the contour, the transparency ranging from 0% to 100%.

19. The mobile device of claim 18, wherein the contour of the target to be aligned comprises at least one of an external contour or an internal contour.

20. The mobile device of claim 19, wherein the target comprises a primary target and a secondary target, and the displaying, using a line, the contour of the target to be aligned comprises:
displaying, using at least one of a first color or a line of a first type, a contour of the primary target to be aligned; and
displaying, using at least one of a second color or a line of a second type, a contour of the secondary target to be aligned;
wherein the mobile device is smart camera, or a mobile phone having a camera.

21. A photographing method, implemented by a mobile phone, wherein the mobile phone comprises a touch panel and a display screen, or a touch screen, and the method comprises:
displaying a standby user interface;
determining a reference photo of the mobile phone according to information obtained by a user;
receiving a click on the reference photo to select at least one target;
in response to the click having been received, automatically starting a marker extraction of the at least one target for aligning in the reference picture; and
displaying the marker of the at least one target for aligning in the display screen.

22. The photographing method of claim 21, wherein the mobile phone further comprises a front-facing camera, and the method further comprises:
starting the front-facing camera to collect an image; and
performing a photography alignment function corresponding to the reference photo and the image from the front-facing camera.

23. The photographing method of claim 21, wherein:
the target comprises a primary target and a secondary target; and
the method further comprises:
displaying a contour of the primary target for aligning by using a first color or a line of a first type; and
displaying a contour of the secondary target for aligning by using a second color or a line of a second type.
